(19) United States
(12) Patent Application Publication
(10) Pub. No.: US 2003/0006744 A1
(43) Pub. Date: Jan. 9, 2003

(54) Soft start circuit

(76) Inventor: Patrik Bostrom, Husqvarna (SE)

Correspondence Address: HARNESS, DICKEY & PIERCE, P.L.C., P.O. BOX 828, BLOOMFIELD HILLS, MI, 48303, US

(21) Appl. No.: 09/979,336

(22) PCT Filed: May 19, 2001
(86) PCT No.: PCT/SE00/01016

(30) Foreign Application Priority Data
May 20, 1999 (SE) 9901839-2

(51) Int. Cl. H02H 7/00

(52) U.S. Cl. 323/283; 361/18; 363/50

(57) ABSTRACT

To eliminate overshoots of an output voltage from a DC/DC voltage converter (1) during start-up of the converter as well as during recovery after a short-circuit of a first and a second output terminal (5,5′) of the converter, a circuit (R2, R3, R4, C1, D2) is provided for generating, during a predetermined interval, a signal that is proportional to the rate of increase of the output voltage of the converter (1) to be supplied to the input of an error amplifier (4) to be superimposed on an error signal corresponding to a difference between an actual value and a set desired value of the output voltage of the converter (1), supplied to a control circuit (3) controlling the converter (1).

### TECHNICAL FIELD

The invention relates generally to soft start of DC/DC voltage converters and more specifically to an arrangement for eliminating overshoots of an output voltage from a DC/DC voltage converter during start-up of the converter as well as during recovery after a short-circuit of the converter output.

### BACKGROUND OF THE INVENTION

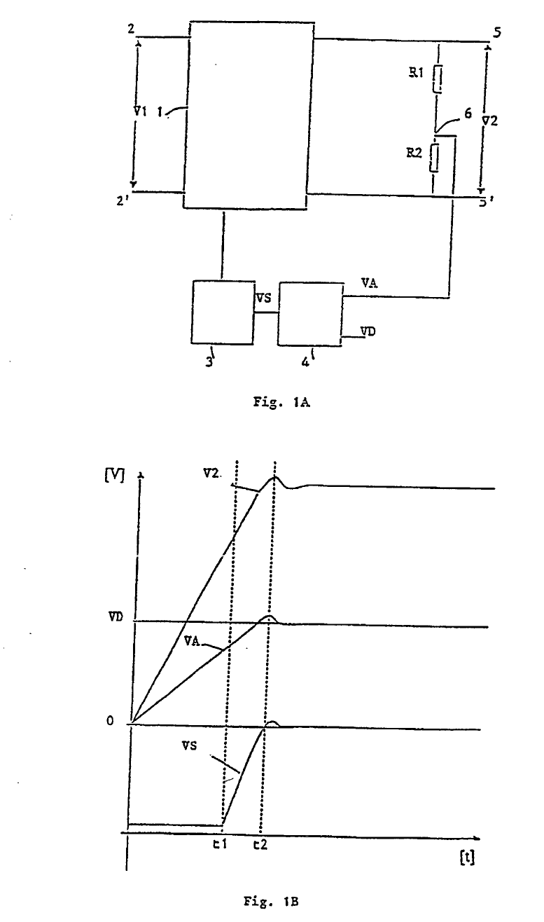

FIG. 1 is a block diagram of a known DC/DC voltage converter arrangement.

A DC/DC voltage converter 1 is supplied with an input DC voltage V1 on its input terminals 2, 2′ to be converted into an output DC voltage V2 on its output terminals 5, 5′.

The DC/DC conversion in the converter 1 takes place under control of a control circuit 3 in response to an error signal VS from an error amplifier 4. The error amplifier 4 amplifies the error between a voltage value VD that is proportional to a desired value of the DC output voltage and a voltage value VA that is proportional to the actual DC output voltage V2 on the output terminals 5, 5′ of the converter 1.

The error amplifier 4 is preferably optically connected to the control circuit 3, i.e. the error signal is optically transmitted from the error amplifier 4 to the control circuit 3, but can of course be connected otherwise.

The desired output voltage value VD is set in a manner known per se and will not be described further.

The voltage value VA, proportional to the actual DC output voltage V2, is obtained from an interconnection point 6 between two resistors R1 and R2 connected in series between the output terminals 5, 5′ of the converter 1 as apparent from FIG. 1.

FIG. 1B illustrates, as a function of time t, the actual output voltage V2, the voltage VA proportional thereto, the set desired voltage value VD, and the error signal VS upon start-up of the converter 1 or upon recovery after a short-circuiting of the output terminals 5, 5′ of the converter 1.

The output voltage V2 and, consequently, also the voltage VA immediately start to increase, while the error signal VS remains constant at a maximum negative voltage value as long as the error amplifier 4 is in a saturated state. In FIG. 1, the saturated state of the error amplifier 4 is supposed to last until time t1. At that time, the difference between VD and VA is supposed to be small enough for the error amplifier 4 to leave its saturated state and enter its linear state, i.e. the error signal VS starts to increase.

V2 and VA continue to increase until VS=0 at time t2. At that time, V2 has increased so much that VA>VD due to delays in the converter arrangement. This causes an overshoot in the output voltage V2. After time t2, VS continues to increase causing V2 and VA to stabilize at the desired output voltage value.

To eliminate such overshoots of the output voltage of DC/DC converters, it is known to use so called soft start of DC/DC converters. The desired value of the output voltage or the primary current is simply increased slowly during the start up allowing the control circuits to stabilize. However, the traditional use of soft start has a disadvantage in that the soft start function is obtained by charging a capacitor via the primary voltage of the converter. This means that upon a short-circuiting of the output terminals of the converter, the output voltage will be forced down to zero by a current limiting control circuit, but the soft start capacitor that is fed by the primary voltage will not be discharged and therefore a recovery from a short-circuit will take place without soft start.

### SUMMARY OF THE INVENTION

The object of the invention is to eliminate the problem with the known soft start solutions.

This is attained in accordance with the invention by instead applying the soft start to the secondary side of the converter.

Hereby, the soft start capacitor wilt be discharged as soon as there is no voltage on the secondary side and the error amplifier will have time to stabilize before the output voltage reaches its desired value.

More specifically, a signal that is proportional to the rate of increase of the output voltage of the converter is supplied to the input of the error amplifier during a predetermined period of the start-up.

### BRIEF DESCRIPTION OF THE DRAWING

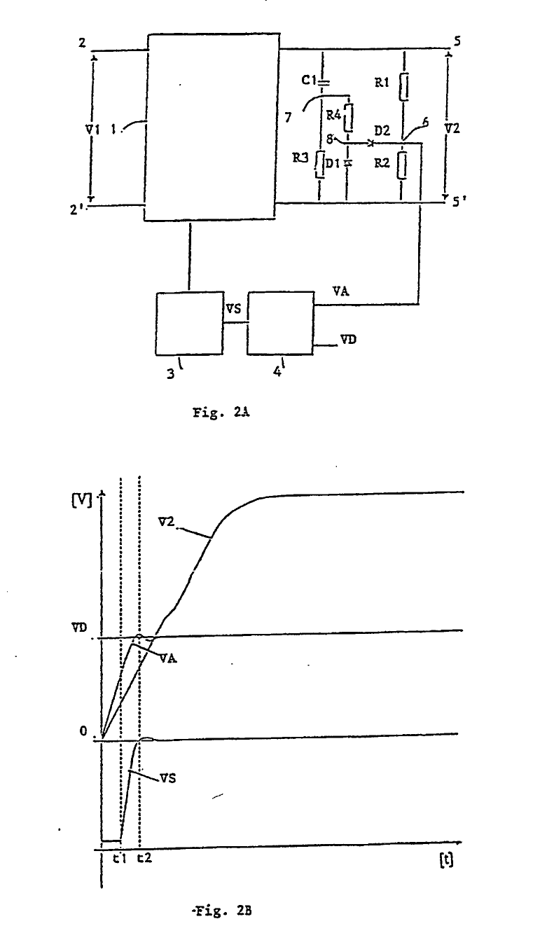

The invention will be described more in detail below with reference to the appended drawing on which FIG. 1A is a block diagram of a known DC/DC voltage converter arrangement, FIG. 1B illustrates different signals in the arrangement in FIG. 1A, FIG. 2A is a block diagram of a DC/DC voltage converter arrangement in accordance with an embodiment of the invention, and FIG. 2B illustrates different signals in the arrangement in FIG. 1A.

### DESCRIPTION OF THE INVENTION

FIG. 2A is a block diagram of a DC/DC voltage converter arrangement in accordance with an embodiment of the invention.

Blocks and signals in FIG. 2A that are the same as corresponding blocks and signals in FIG. 1A have been provided with the same reference numerals and characters.

In FIG. 2A, the DC/DC voltage converter arrangement comprises an embodiment of a circuit for eliminating overshoots of the converter output voltage during start-up as well as during recovery after a short-circuit of the converter output.

The embodiment of the circuit for preventing overshoots of the output voltage V2 of the converter 1 in accordance with the invention, comprises a capacitor C1 that is connected in series with a resistor R3 between the output terminals 5, 5′ of the converter 1. An interconnection point 7 between the capacitor C1 and the resistor R3 is connected to the output terminal 5′ of the converter 1 via a resistor R4 that is connected in series with a diode D1. In the embodiment in FIG. 2A, the anode of the diode D1 is connected to the output terminal 5′, while its cathode is connected to the resistor R4.

The interconnection point 8 between the cathode of the diode D1 and the resistor R4 is connected to the interconnection point 6 between the resistors R1 and R2 via a diode D2.

With reference to the diagram in FIG. 2B, the operation of the arrangement in accordance with the invention upon start-up of the converter 1 or upon recovery after to the output terminals 5, 5′ of the converter 1 have been short-circuited, will be described.

However, upon start-up of the converter 1 as well as upon recovery of the converter 1 after that its output terminals 5, 5′ have been short-circuited, the capacitor C1 that is now completely discharged, will be charged via the resistor R3 and via the resistor R4, the diode D2, and the resistor R2.

With reference to FIG. 2B, the voltages V2 and VA will immediately start to increase.

The capacitor charging current through the resistor R4, the diode D2, and the resistor R2 will increase the voltage VA, i.e. the voltage in the interconnection point 6, proportionally to the rate of increase of the output voltage V2.

This causes time t1, i.e. the time when the error amplifier 4 leaves its saturated state for the linear state, to occur much earlier than in FIG. 1B.

Also time t2, i.e. the time when VS=0, will occur much earlier than in FIG. 1B.

Hereby, VS=0 will occur long before V2 reaches its desired end value.

The charging current of the capacitor C1 will decrease with increasing voltage across the capacitor C1. Thereby, V2 will increase since VD−VA is to be zero.

The capacitor C1 will continue to be charged via the resistor R4, the diode D2 and the resistor R2 until the diode D2 is reverse biased. Thereafter, the capacitor C1 is fully charged via the resistor R3.

Then, the soft start of the converter 1 is completed.

The time the circuit according to the invention operates, i.e. the time until the capacitor C1 is fully charged, is predetermined in the application in question by the capacitance value of the capacitor C1 as well as by the resistance values of the resistors R3, R4, and R2.

The output voltage V2 of the converter 1 will increase in accordance with a capacitor characteristic as apparent from FIG. 2B.

From now on, the control circuit 3 will control the converter 1 in accordance with the actual output voltage V2.

The purpose of the diode D1 is to quickly discharge the capacitor C1 via the resistor R4 instead of via the resistor R3.

Even if the short-circuiting is so short that the capacitor C1 is not completely discharged, the soft start circuit according to the invention will not completely be out of action. If the actual voltage is e.g. 25V and a short-circuit that lasts e.g. 2 ms brings the output voltage V2 to e.g. 15V, the capacitor C1 will have been discharged to about 20V which means that the control circuit 3 will start its controlling function at a voltage of about 23.5V, whereby any overshoot will be eliminated.

As should be apparent from the above, overshoots of the output voltage of a DC/DC voltage converter will be eliminated by means of a circuit according to the invention.

1. An arrangement for eliminating overshoots of an output voltage from a DC/DC voltage converter (1) during start-up of the converter as well as during recovery of the converter after a short-circuit of a first and a second output terminal (5, 5′) of the converter, wherein a control circuit (3) is connected with its output terminal to a control input terminal of the converter (1) to supply a control signal thereto in response to that the control circuit (3) on its input terminal receives an error signal from an output terminal of an error amplifier (4) connected with an input terminal to an interconnection point (6) between two resistors (R1, R2) connected in series between said first and second output terminals (5, 5′) of the converter (1), said error signal corresponding to a difference between an actual value and a set desired value of the output voltage of the converter (1), characterized in that a circuit for generating, during a predetermined interval, a signal that is proportional to the rate of increase of the output voltage of the converter (1) is connected with its input terminals between said first and second output terminals (5, 5′) of the converter (1) and with its output terminal to said interconnection point (6) to supply that signal to said input terminal of the error amplifier (4) to be superimposed on said error signal to the control circuit (3).

2. The arrangement as claimed in claim 1, characterized in that said circuit comprises a capacitor (C1) connected in series with a first resistor (R3) between said first and second output terminals (5, 5′) of the converter (1), and a second resistor (R4) connected with its one terminal to the interconnection point (7) between said capacitor (C1) and said first resistor (R3) and with its other terminal to the anode of a first diode (D2), the cathode of which being connected to said interconnection point (6) between said two resistors (R1, R2).

3. The arrangement as claimed in claim 2, characterized in that a second diode (D1) is connected with its cathode to the interconnection point (8) between said second resistor (R4) and the anode of said first diode (D2) and with its anode to said second output terminal (5) of the converter (1).
